(19) United States
(12) Patent Application Publication
(10) Pub. No.: US 2004/0096289 A1
(43) Pub. Date: May 20, 2004

(54) Fastener assembly

(76) Inventors: Theodore Bydalek, Buffalo Grove, IL (US); David Harris, Fulton, IL (US); Larry Wilson, Commerce Twp, MI (US)

Correspondence Address: Dana Andrew Alden, MacLean-Fogg Company, 1000 Allanson Road, Mundelein, IL, 60060, US

(21) Appl. No.: 10/712,611

(22) Filed: Nov. 13, 2003

Related U.S. Application Data
(63) Continuation-in-part of application No. 09/933,312, filed on Aug. 20, 2001.

(51) Int. Cl. F16B 39/24

(52) U.S. Cl. 411/161

(57) ABSTRACT

The present invention relates to a fastener assembly, comprising a nut configured to retain a cap, a washer having a bearing surface, the nut and the washer being rotatable relative to each other about a common axis, the nut having an annular surface axially opposed to the bearing surface, and the annular surface and the bearing surface are undulating in shape.

This is a continuation-in-part of application Ser. No. 09/933,312, filed on Aug. 20, 2001, the disclosure of which is hereby incorporated by reference.

### FIELD OF THE INVENTION

This invention relates to fastener assemblies, and particularly to fastener assemblies provided with a cap.

### BACKGROUND OF THE INVENTION

Fasteners are known in the art and are used for threading onto a threaded member. The present invention is an improved fastener that is provided with a cap.

### SUMMARY OF THE INVENTION

The scope of the present invention is defined solely by the appended claims, and is not affected to any degree by the statements within this summary. Briefly stated, a fastener assembly, comprising a nut configured to retain a cap, a washer having a bearing surface, the nut and the washer being rotatable relative to each other about a common axis, the nut having an annular surface axially opposed to the bearing surface, and the annular surface and the bearing surface are undulating in shape.

### BRIEF DESCRIPTION OF THE DRAWINGS

FIG. 1 is an end view of a vehicle axle and wheel hub having a fastener assembly of the preferred embodiment threaded onto a stud and a fastener assembly of an alternative embodiment threaded onto a spindle;

FIG. 2 is a sectional view taken along line 2-2 of FIG. 1;

FIG. 3 is an exploded perspective view a washer of an alternative embodiment;

FIG. 4 is a bottom plain view, partially in section, of a fastener assembly of an alternative embodiment;

FIG. 5 is a top plain view, partially in section, of a fastener assembly of an alternative embodiment;

FIG. 6 is a side elevational view, partially in section, of a nut and washer of an alternative embodiment;

FIG. 7 is a plain view of a quarter segment of overlying annular and bearing surfaces of a nut and washer, respectively, of an alternative embodiment, showing their relationship to each other circumferentially;

FIG. 8 is an enlarged sectional view of an arcuate portion (on an 180 arc in the present illustration) of the faces and faces mating in the assembly of an alternative embodiment, the view depicting curved surfaces as straight because of this;

FIG. 9 is a side elevational view of a nut of an alternative embodiment, showing the convex curvature of its inclined faces;

FIG. 10 is a side sectional view through the washer of an alternative embodiment, showing the concave curvature of its inclined faces;

FIG. 11 is a side elevational view of a nut of the preferred embodiment;

FIG. 12 is a side elevational view of a nut of the preferred embodiment;

FIG. 13 is a side elevational view, in section, of a washer of the preferred embodiment;

FIG. 14 is an exploded perspective view of a fastener assembly of the preferred embodiment;

FIG. 15 is a bottom plain view, partially in section, of a fastener assembly of the preferred embodiment;

FIG. 16 is a top plain view, partially in section, of a fastener assembly of the preferred embodiment;

FIG. 17 is a bottom plain view of a cap of the preferred embodiment;

FIG. 18 is a side elevational view of a cap of the preferred embodiment;

FIG. 19 is side elevational view of a fastener assembly of the preferred embodiment;

FIG. 20 is a side elevational view, in section, of a fastener assembly of the preferred embodiment;

FIG. 21 is a close-up view of a frictional surface on the nut of the preferred embodiment;

FIG. 22 is a close up view of a frictional surface on the cap of an alternative embodiment;

FIG. 23 is a close up side elevational view of an annular surface on a nut of an alternative embodiment;

FIG. 24 is a side elevational view, in section, of a bearing surface on a washer of an alternative embodiment;

FIG. 25 is a side elevational view, in section, of a washer of an alternative embodiment;

FIG. 26 is a close up side elevational view, in section, of a clamping surface on a washer of an alternative embodiment;

FIG. 27 is a side elevational view, in section, of a washer of an alternative embodiment;

FIG. 28 is a side elevational view, in section, of a cap and a nut of the preferred embodiment in relation to a socket from a socket wrench;

FIG. 29 is a side elevational view, in section, of a cap and a nut of the preferred embodiment;

FIG. 30 is a side elevational view, in section, of a cap and a nut of the preferred embodiment in relation to a stud;

FIG. 31 is a side elevational view, in section, of a bearing surface on a washer of an alternative embodiment;

FIG. 32 is a side elevational view, in section, of a washer of an alternative embodiment;

FIG. 33 is a close up side elevational view of the annular surface on the nut of an alternative embodiment;

FIG. 34 is a side elevational view, in section, of the fastener assembly of an alternative embodiment in relation to a stud having a notch;

FIG. 35 is a side elevational view, in section, of the fastener assembly an alternative embodiment;

FIG. 36 is an exploded perspective view of a fastener assembly of an alternative embodiment;

FIG. 37 is an exploded perspective view of a partially finished nut of the presently preferred embodiment; and

FIG. 38 is a bottom plain view, partially in section, of a fastener assembly of an alternative embodiment.

### DETAILED DESCRIPTION OF THE PREFERRED EMBODIMENTS

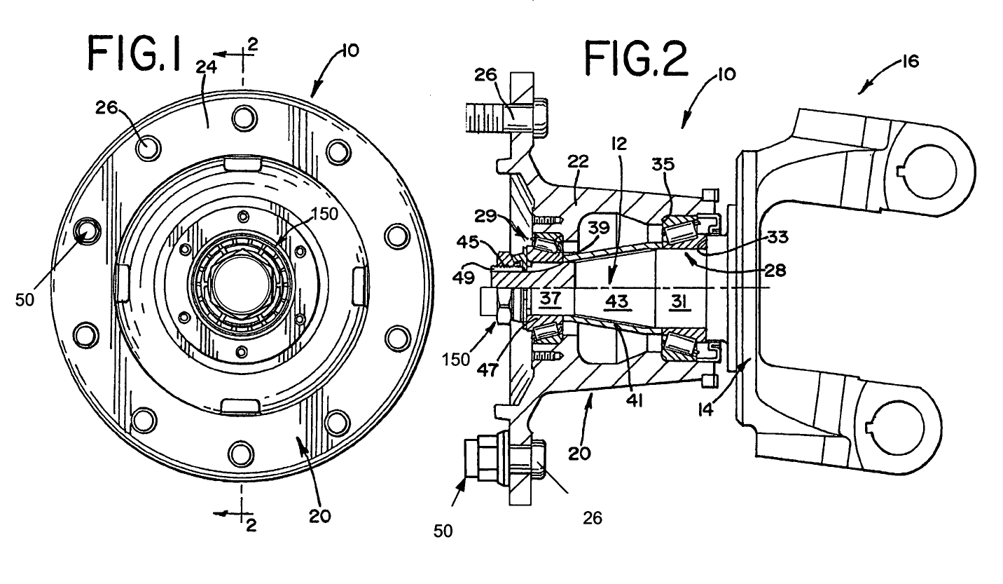

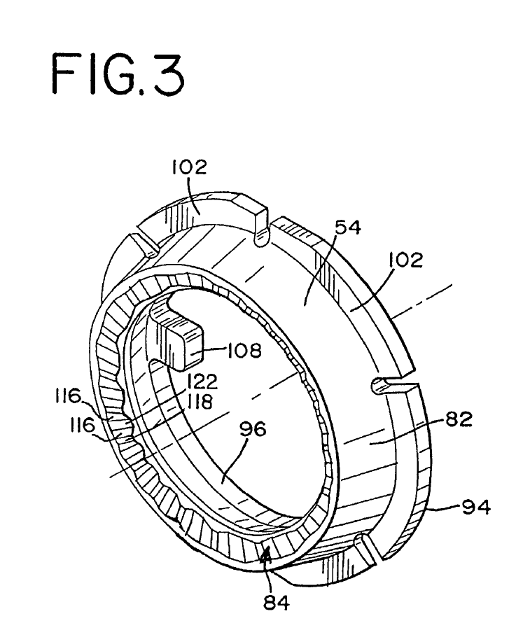

Referring to FIGS. 1 and 2, an axle assembly for an automotive vehicle is shown generally at 10. The axle assembly 10 includes a stud 26, in the form of spindle 12, which extends horizontally from a vertically oriented plate 14. The plate 14 forms the outer face of a fitting 16 which is mounted in a conventional manner on the frame (not shown) of a vehicle.

Seated for rotation on the spindle 12 is a wheel hub 20. The wheel hub 20 includes a generally cylindrical body 22. The wheel hub 20 is seated on the spindle 12 on an inner roller bearing assembly 28 and an outer roller bearing assembly 29. The inner bearing assembly 28 is located on a cylindrical inner section 31 of the spindle 12 and is retained between a shoulder 33 on the spindle and an opposing shoulder 35 inside the body 22 of the wheel hub 20. The outer bearing assembly 29 is located on a cylindrical outer section 37 of the spindle 12 and is seated against a shoulder 39 inside the hub body 22 and against a frusto-conical spacer 41 encircling the tapered mid-section 43 of the spindle on the inner end of the bearing assembly.

The cylindrical body 22 is formed unitarily with a radially extending flange 24. A plurality of studs 26 extend axially from the flange 24 near its periphery. The studs 26 are employed in a conventional manner to mount a wheel (not shown) on the wheel hub 20. As depicted in FIGS. 1 and 2 the fastener assembly 50 of a presently preferred embodiment is threaded onto stud 26.

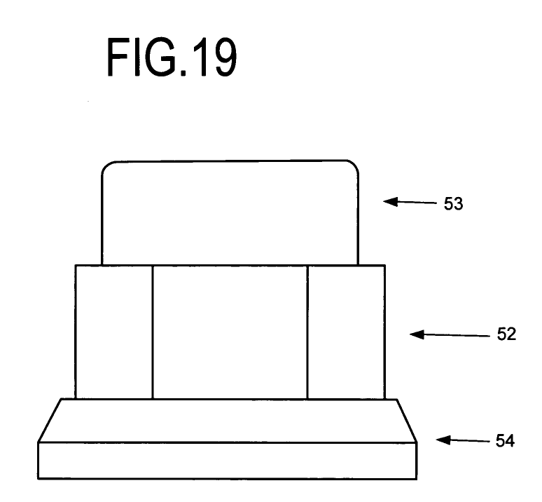

Referring now to FIG. 19, the presently preferred embodiment of the fastener assembly 50 is depicted. As depicted therein, the fastener assembly 50 is provided with a nut 52. The nut 52 includes a metal, preferably a carbon steel, such as 1020 to 1045 steel.

The nut body 62 shown in FIG. 19 is forged. The steel is first heated to 2100° F., cut into segments, and pressed so that it is circular and larger in diameter. Then a portion of the inner surface 63 and a torque transmitting surface 66 are forged. Thereafter, a portion of the inner surface 63 is punched out and the nut 52 is then heat treated to an average hardness ranging between 26 and 36 on the Rockwell C scale, preferably 31.

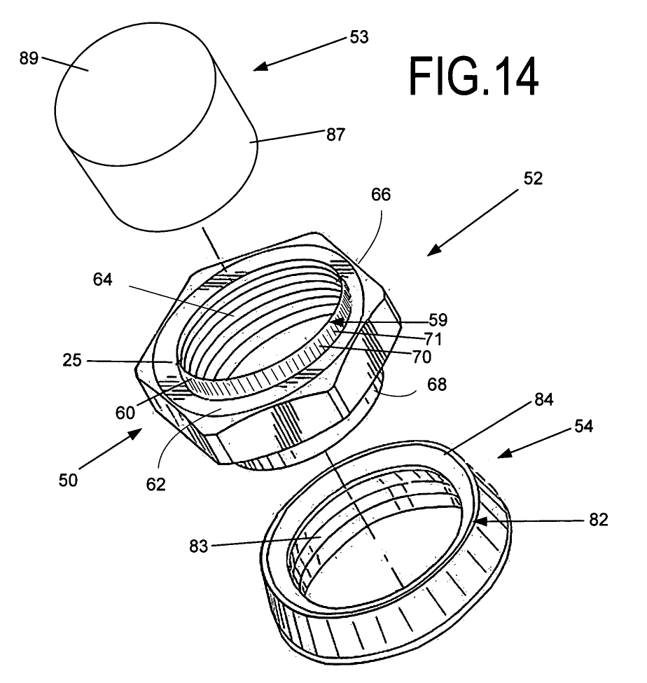

The washer body 82 of the preferred embodiment, depicted in FIG. 14, is fabricated from an alloy grade steel, such as 4140 steel. In an alternative embodiment, a medium carbon steel such as 1020 to 1045 steel is used. It is preferred that the washer body 82 is fabricated through forging. The steel is first heated to 2100° F., cut into segments, and pressed so that it is circular and larger in diameter. Then, an annulus is formed and punched out. The washer body 82 is heat treated to an average hardness ranging between 28 and 42 on the Rockwell C scale, preferably 36.

The nut 52 and washer 54 are assembled together. The nut 52 is mated with the washer 54 and then a skirt 68 on the nut is flared out to form a collar 85. The collar 85 advantageously provides a lead for the threads 64. Then, a tap is sent down through the nut body 62, and threads 64 are cut into the nut body 62. The threads 64 have a diameter preferably in the range of approximately 0.3125 inches, up to approximately 1.25 inches.

After the threads 64 have been cut, the nut body 62 is put through a machining center. The minor diameter of the threads 64 within the nut body 62 is chucked and then turned or grooved. The nut 52 is placed on a collet or mandrel and turned or grooved. The collet grips the minor diameter sufficiently to prevent slipping and the nut body 62 is spun around. A grooving tool is plunged into the side of the nut body 62 and shaves off material so that the previously hexagonal shape is more desirably shaped for a retaining surface 59.

After the nut body 62 is turned or grooved, a frictional surface 70 is fashioned into the retaining surface 59. The frictional surface 70 is fabricated using a knurling tool. In the preferred embodiment, the knurling tool is configured to impress a “right hand” notch 71 at an angle ranging between 30 to 60 degrees, preferably 45 degrees. In an alternative embodiment, a “left hand” notch 71 at similar angles may be fabricated without departing from the scope of the present invention.

The nut body 62 and/or the washer body 82 may advantageously be provided with a coating. Preferably, the coating is of a formulation that prevents rust and/or corrosion; however, other coatings may be used. By way of example, and not limitation, the coating may be a formulation that reduces friction. In one embodiment, the coating reduces friction between the nut and the washer. In another embodiment, the coating reduces friction within the threads.

Various chemical compounds may be used as suitable coatings. In one embodiment, polytetrafluoroethylene or PTFE is used. In another embodiment, a zinc coating is used. In yet another embodiment, a water-based coating dispersion containing metal oxides and/or aluminum flakes is used.

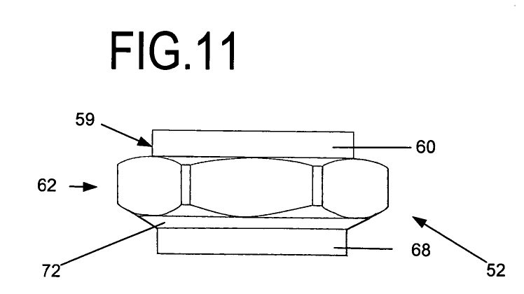

As shown in FIG. 11, the nut 52 is provided with a retaining surface 59. The retaining surface 59 cooperates with a cap 53. The retaining surface 59 is configured to retain the cap 53. FIG. 11 depicts the cap 53 retained on the nut 52 so that an interference fit is achieved between the cap and the retaining surface 59.

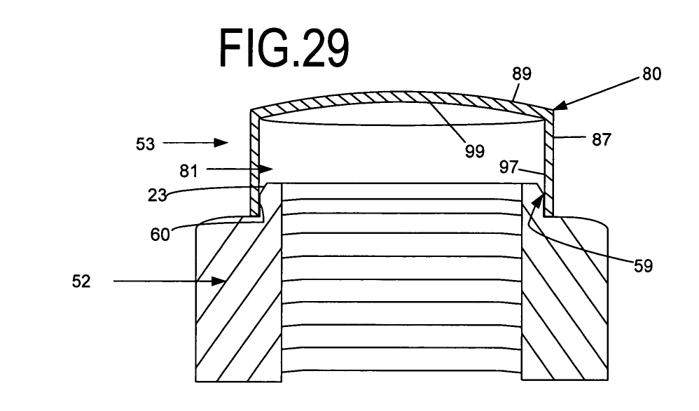

The retaining surface 59 of the preferred embodiment is provided with a first surface 60. The first surface 60 is shaped correspondingly to at least a portion of the inner surface 81. As shown in FIG. 29, the first surface 60 is shaped so that an interference fit can be achieved with the cap 53. Consequently, the first surface 60 can be provided with a plurality of shapes. In the preferred embodiment, the first surface 60 is generally cylindrical.

The retaining surface 59 is provided with a second surface 23. The second surface 23 is shaped so that the cap 53 can be placed on the nut 52 with greater ease. FIG. 29 depicts the second surface 23 shaped to accommodate the cap 53. As depicted therein, the second surface 23 is generally conical in shape. While the preferred embodiment is shown with a second surface 23, the retaining surface 59 may be fabricated without a second surface 23.

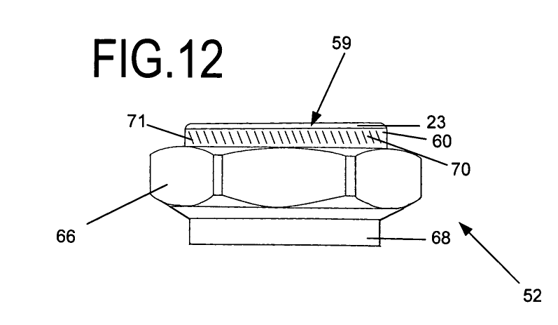

As shown in FIG. 12, it is advantageous to provide the retaining surface 59 with a frictional surface 70. Advantageously, the frictional surface 70 renders the retaining surface 59 better able to retain the cap 53 through interference fit.

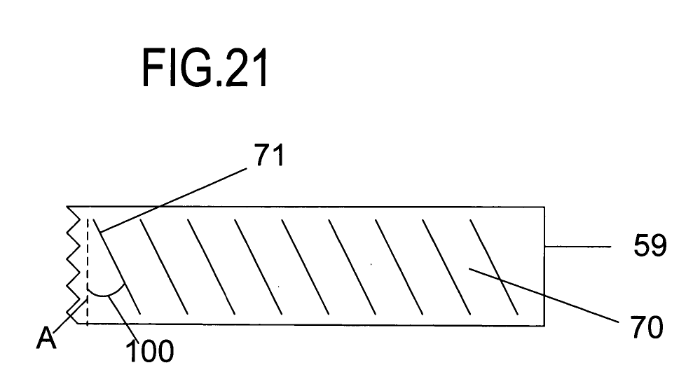

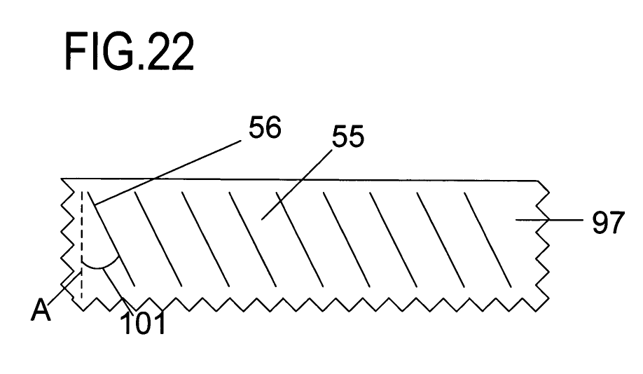

The frictional surface 70 is provided with a higher frictional coefficient. The higher frictional coefficient obtained in the preferred embodiment is achieved by knurling the frictional surface 70. The frictional surface 70 is preferably provided with a plurality of notches 71. As depicted in FIG. 21, the notches 71 are at an Angle 100 with respect to the axis of the nut depicted as imaginary line A. Angle 100 ranges from 30° to 60°, preferably 45°.

In the preferred embodiment the nut 52 is provided with a nut body 62. As depicted in FIG. 14, the nut body 62 is provided with threads 64. The internal threads at 64 preferably extend to an internal portion of the retaining surface 59 and an internal portion of a skirt 68.

The nut body 62 is provided with a torque transmitter 66. As shown in FIG. 14 the torque transmitter 66 is provided on the external surface of the nut body 62. The torque transmitter 66 is shaped to transmit torque, preferably via a plurality of surfaces. As depicted in FIG. 14, the torque transmitter 66 is hexagonal in shape.

Referring now to FIG. 11, the nut body 62 is provided with an annular surface 72. The annular surface 72 is located adjacent to the torque transmitter 66. The annular surface 72 is preferably generally frusto-conical in shape. In alternative embodiments, that the annular surface 72 is spherically concave or spherically convex. In yet another alternative embodiment, the annular surface 72 is shaped to cooperate with a surface of the object being fastened; in such an embodiment a washer is unnecessary.

The annular surface 72 is preferably fabricated by cold forging. The cold forging is accomplished through the use of a die insert. The die insert is machined to the desired shape using conventional ball end mill techniques.

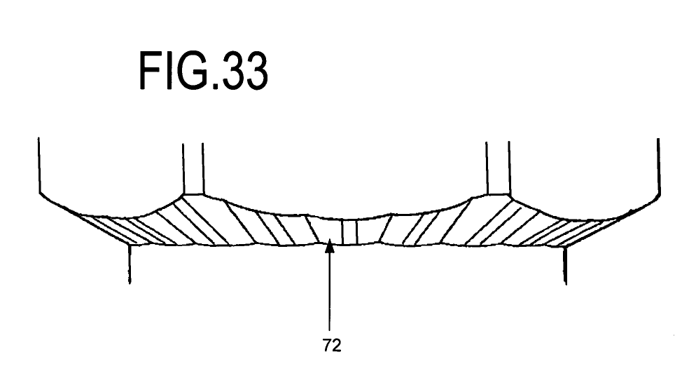

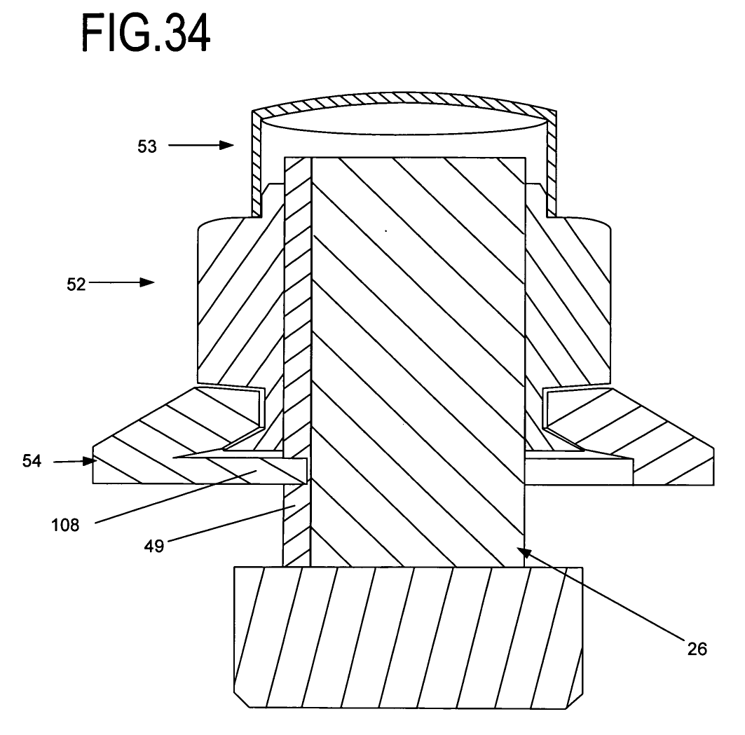

In an alternative embodiment the annular surface 72 is configured to cooperate with a bearing surface 84. As shown in FIG. 33 the annular surface 72 is undulating in shape. The annular surface 72 is provided with an annularly extending series of surfaces, which provide a uniform undulation around the entire annular surface 72.

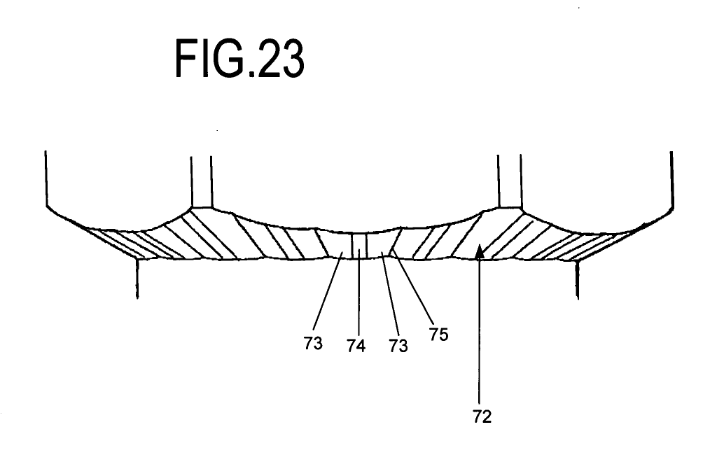

FIG. 23 depicts yet another alternative embodiment of the present invention. As depicted therein, the annular surface 72 is provided with a plurality of lower peaks. The lower peaks are provided as plateaus 74.

The plateaus 74 are generally spherically convex. The plateaus 74 are provided with the same radius as the valleys 122 on the bearing surface 84. The plateaus 74 are formed in the cold forging process so that they are all convex and lie on the surface of an imaginary sphere whose center is on the axis of the nut body 62. The radius of that sphere ranges from 0.1 inches to 2.00 inches.

The plateaus 74 are adjacent to a plurality of faces 73. Each plateau 74 is adjacent to a pair of faces 73 that are oppositely inclined. The annular surface 72 of this alternative embodiment is provided with an annularly extending series of faces 73, which form a uniform undulation around the entire surface. The faces 73 are configured to be complementary to corresponding faces 116 on the bearing surface 84. The faces 73 are provided with the same radius as the faces 73 on the bearing surface 84.

As depicted in FIG. 23, the faces 73 are preferably generally spherically convex. Each face 73 is formed so that it is convex and is curved both radially and circumferentially with respect to the nut body 62.

Each face 73 is adjacent to a valley 75. Each valley 75 is adjacent to a pair of faces 73. The valleys 75 are configured to be narrower than valleys 122 on the bearing surface 84. As depicted in FIG. 23, the valleys 75 are generally spherically convex and have a predetermined depth. In one embodiment, the depth is dimensioned according to the number of threads on the nut.

The valley 75 and adjacent faces 73 of the alternative embodiment provide a generally inverted Vee shaped profile. The Vee shaped profile provides the plateaus 74 with a height. Advantageously, the height is dimensioned according to the distance between the plateau segment 74 and the valley 75. In the embodiment shown herein, the height equals the vertical distance between the plateau 74 and the valley 75. The height is preferably slightly greater than the clearance between the threads at 64 and those on a stud 26, when the fastener assembly 50 is in place. In this alternative embodiment, the height ranges between 0 inches and 0.030 inches

In an alternative embodiment, the height is dimensioned according to the number of threads, measured axially, per inch on the nut. Advantageously the height is related to the number of faces 73 or faces 116. By way of example and not limitation the height, in inches, is proportional to the number of threads per inch and the number of Vee shaped undulations. In the preferred embodiment, the height is proportional to the product of the number of threads per inch and the number of Vee shaped undulations. The height of this alternative embodiment ranges up to approximately 0.04167 of an inch.

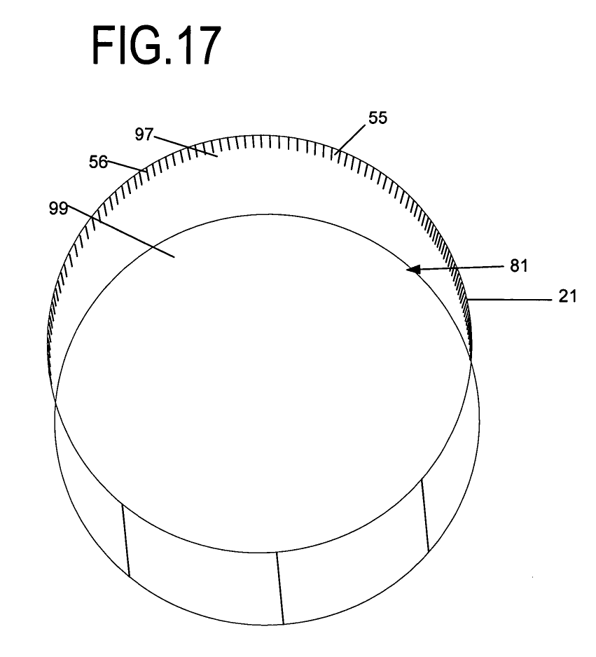

FIG. 14 depicts the nut body 62 provided with a seating surface 25. As shown in FIG. 17, the seating surface 25 advantageously corresponds to an intermediate portion 21 of the cap 53. The seating surface 25 is contoured to correspond to the intermediate portion 21. As depicted in FIG. 14, the seating surface 25 is annular in shape. The seating surface 25 is provided with a higher frictional coefficient to inhibit rotation of the cap 53 with respect to the nut 52.

As shown in FIG. 14, the nut 52 is provided with a skirt 68. The skirt 68 extends axially away from the nut body 62 at the inner end of internal threads 64. The skirt 68 is configured to cooperate with a washer 54. The skirt 68 is shaped to retain a washer 54 in a loose relationship. In the preferred embodiment, the skirt 68 is adapted to extend axially from the annular surface 72 into the generally cylindrical washer body 82 whereupon it is formed outwardly under an undercut shoulder within the washer body 82 to loosely but securely hold the washer 54 and nut 52 together.

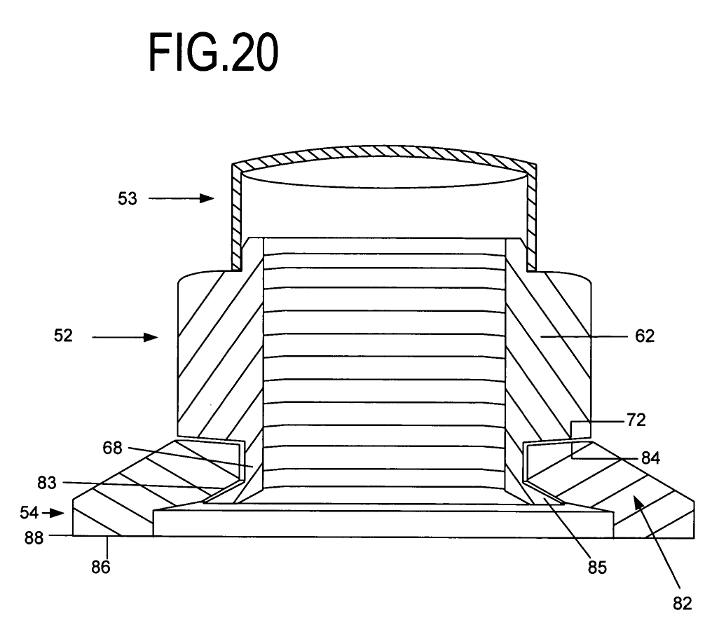

Referring now to FIG. 11, the skirt 68 is unitarily formed and depends from the nut body 62. As shown in FIG. 20, the skirt 68 is configured to retain the washer. The skirt 68 is configured to underlie a portion of the washer 54, whereby it connects the nut and washer, while permitting the nut 52 and washer to rotate with respect to each other.

In applications that do not require a washer 54, it is desirable for the nut 52 to cooperate with a surface on the object being fastened. Accordingly, in an alternative embodiment, the nut 52 can be fabricated without the skirt 68, without departing from the scope of the present invention.

Referring now to FIG. 19, the fastener assembly 50 is provided with a cap 53. In the preferred embodiment, the cap 53 is composed of an alloy, such as stainless steel; however, in alternative embodiments, the cap 53 may be fabricated from other materials without departing from the scope of the present invention. By way of example and not limitation, the cap 53 may be fabricated from a metal such as aluminum or from a material that includes a polymer.

The cap 53 constituting the presently preferred embodiment is fabricated from a sheet of stainless steel. The preferred method of fabricating the cap 53 is through stamping. However, other methods, such as forming and casting may be employed.

In stamping the cap 53, a round wafer is cut out of the center of the sheet of stainless steel. The wafer is drawn progressively deeper to make it into a cup. Then a final deep drawing elongates the cup into the cap 53.

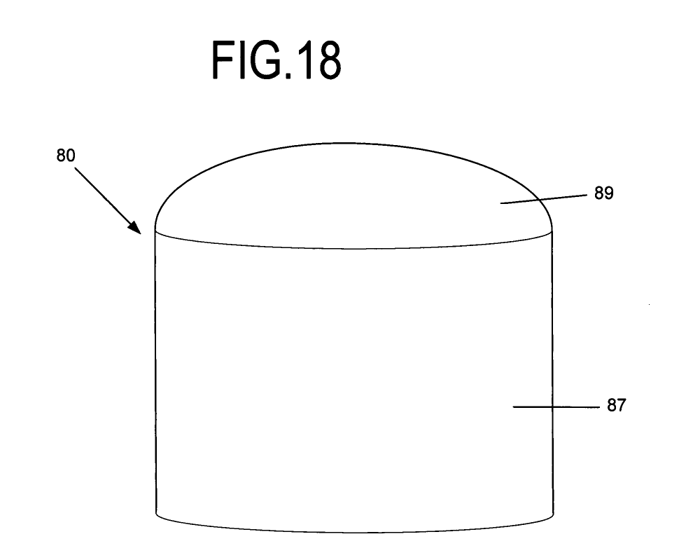

Referring now to FIG. 18, the cap 53 is provided with an outer surface 80. It is preferred that the outer surface 80 be provided with a coating. The coating is of a formulation that prevents rust and/or corrosion. Advantageously, the outer surface 80 is decorative. It is preferred that the outer surface 80 be provided with a light reflecting appearance, such as that provided by the use of stainless steel. In an alternative embodiment, the outer surface 80 is provided with a colorful appearance, such as that made possible through the use of plastic as a material.

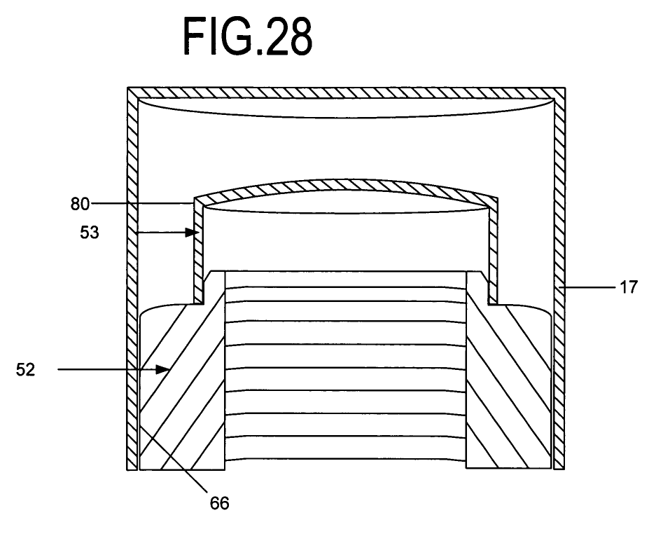

The outer surface 80 is configured to cooperate with a wrench. As shown in FIG. 28, the outer surface 80 is shaped to fit within a socket wrench 17. Advantageously, the outer surface is shaped so that the socket wrench 17 applies torque to the torque transmitter 66 rather than the outer surface 80.

Referring now to FIG. 18, the outer surface 80 is provided with a first outer cap surface 87. As shown in FIG. 29, the first outer cap surface 87 is within the torque transmitter 66. In the preferred embodiment, the first outer cap surface 87 is generally cylindrical in shape.

Adjacent to the first outer cap surface 87 is a second outer cap surface 89, as depicted in FIG. 18. In the preferred embodiment, the second outer cap surface 89 is generally convex.

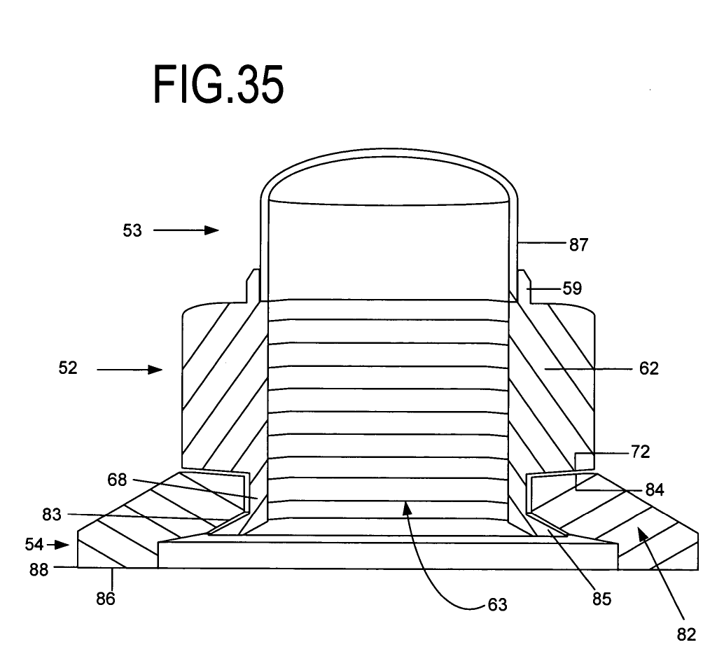

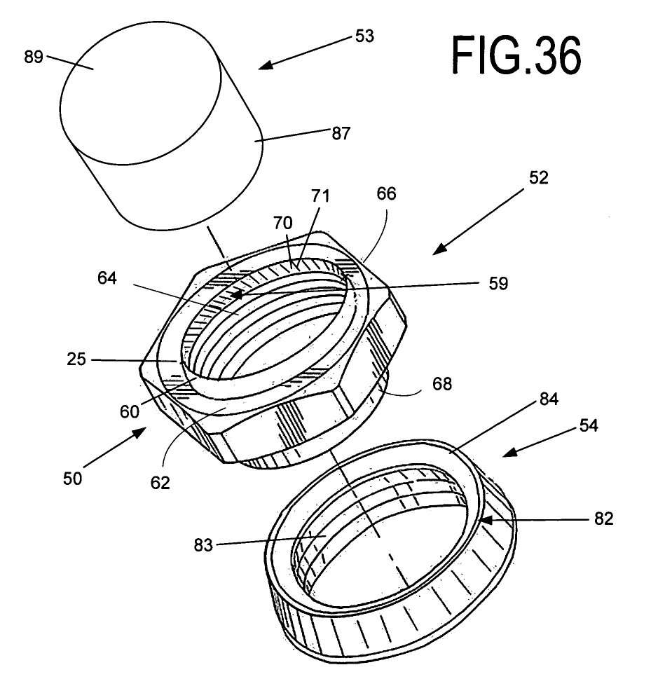

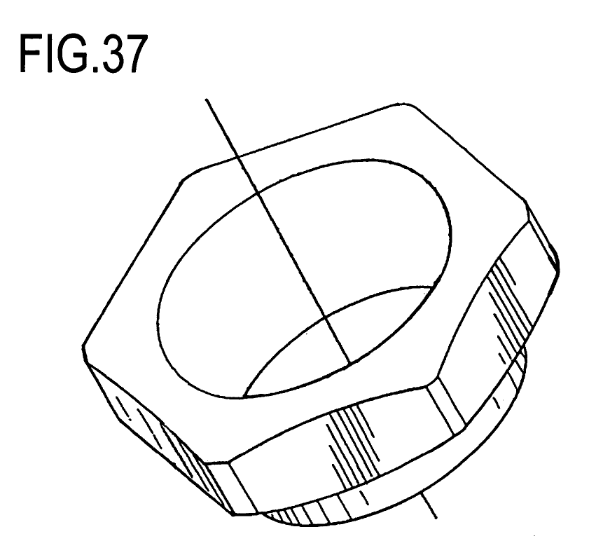

FIGS. 35 and 36 depict an alternative embodiment of the present invention. As shown therein, the inner surface 63 of the nut body 62 is provided with a retaining surface 59. The outer surface 80 of the cap 53 is configured to cooperate with a retaining surface 59.

As shown in FIGS. 35 and 36, the outer surface 80 is provided with a first outer cap surface 87. The first outer cap surface 87 is shaped so that an interference fit can be achieved with the retaining surface 59. The cap 53 is placed within the retaining surface 59 so that the notches 71 dig into the first outer cap surface 87.

In this embodiment, the first outer cap surface 87 is shaped according to the retaining surface 59. As depicted in FIGS. 35 and 36, the alternative embodiment is provided with a generally cylindrical first outer cap surface 87 that corresponds to the retaining surface 59.

In the preferred embodiment, the outer surface 80 of the cap 53 encloses an inner surface 81 that cooperates with the retaining surface 59. In the preferred embodiment, the inner surface 81 is provided with a first inner cap surface 97. The first inner cap surface 97 is configured to cooperate with the retaining surface 59. As shown in FIG. 29, the first inner cap surface 97 is shaped so that an interference fit can be achieved with the retaining surface 59. The cap 53 is placed onto the retaining surface 59 so that the notches 71 dig into the first inner cap surface 97.

The inner surface 81 is shaped according to a surface on the nut body 62. As depicted in FIG. 29, the first inner cap surface 97 is shaped to correspond to the retaining surface 59. In the preferred embodiment, the first inner cap surface 97 is generally cylindrical in shape.

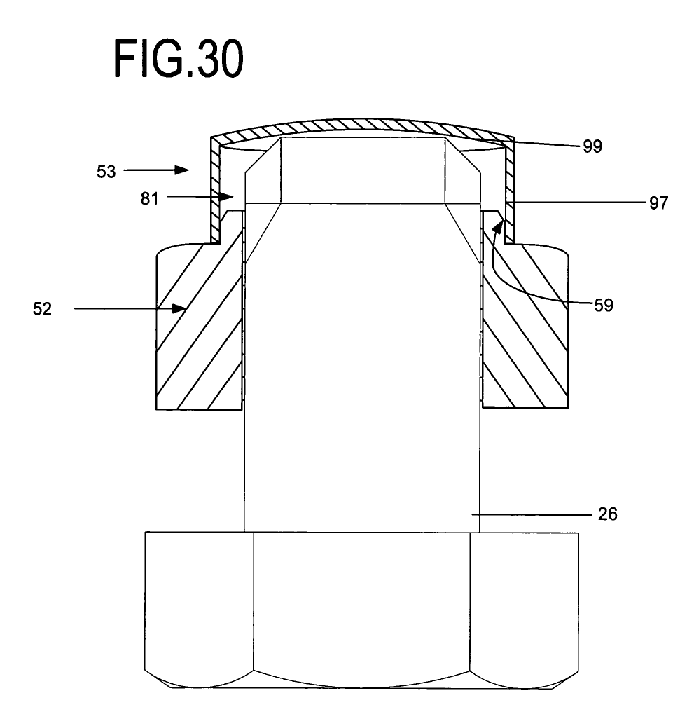

The inner surface 81 is dimensioned to accommodate a stud 26. As depicted in FIG. 30, the first inner cap surface 97 is provided with a diameter that allows at least a portion of a stud 26 to be located within the inner surface 81. The inner surface 81 is provided with a second inner cap surface 99 that is shaped to accommodate the end of the stud 26. In the preferred embodiment, the second inner cap surface 99 is generally concave.

Because a stud, such as the stud 26 depicted in FIG. 1, may vary in length from one stud to another and because a fastener assembly 50 must be properly torqued onto the stud 26 so that a wheel might be safely secured to the wheel hub 20, an unexpectedly long stud 26 might not be accommodated within the inner surface 81 of the cap 53. However, if the inner surface 81 of the cap 53 prevents the complete torquing of the fastener assembly 50, a potentially dangerous condition may arise. To solve this potential problem, the cap 53 is configured to cooperate with the stud 26. The interference fit between the cap 53 and the nut body 62 allows the stud 26 to separate the cap 53 from the nut body 62 so that the fastener assembly 50 may be fully torqued down onto the stud 26.

In an alternative embodiment, the inner surface 81 may be provided with a frictional surface 55. The frictional surface 55 is provided with a higher frictional coefficient. The higher frictional coefficient is achieved by knurling the frictional surface 55.

As shown in FIG. 17, the frictional surface 55 is located within the first inner cap surface 97. The frictional surface 55 is preferably provided with a plurality of notches 56. Referring now to FIG. 22, the notches 56 are at an angle 101 with respect to the axis of the nut, depicted as imaginary line A. Angle 101 ranges from 30° to 60°. Angle 101 is preferably 45°.

In an alternative embodiment, the cap 53 is provided with an intermediate portion 21. Preferably, the intermediate portion 21 corresponds to a seating surface 25. The intermediate portion 21 of the alternative embodiment is contoured to correspond to the seating surface 25. As depicted in FIG. 17, the intermediate portion 21 is preferably annular in shape. The intermediate portion 21 of this alternative embodiment is advantageously provided with a higher frictional coefficient to inhibit rotation of the cap 53 with respect to the nut 52.

Referring now to FIG. 19, the presently preferred embodiment of the fastener assembly 50 is depicted. As depicted therein the fastener assembly 50 is provided with a washer 54, including a washer body 82. The materials of the washer 54 include a metal, preferably an alloy, such as a medium carbon steel. The washer body 82 is fabricated through forging, preferably cold forming. Cold forming is accomplished through the use of a die insert. The die insert is preferably machined to the desired shape using conventional ball end mill techniques. After being forged, the washer body 82 is heat-treated to an average hardness of 36 on the Rockwell C scale.

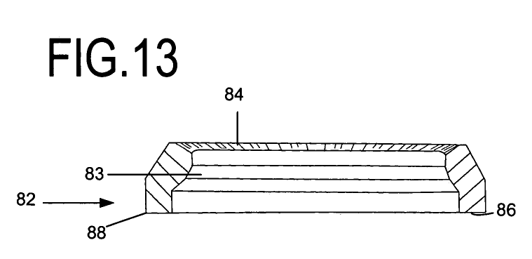

Referring now to FIG. 13, the washer body 82 is generally annular in shape and provided with a bearing surface 84. The bearing surface 84 is preferably in a generally frusto-conical in shape, located on the inner end of the washer,body 82. In alternative embodiments, the bearing surface 84 is spherically concave, spherically convex, and flat.

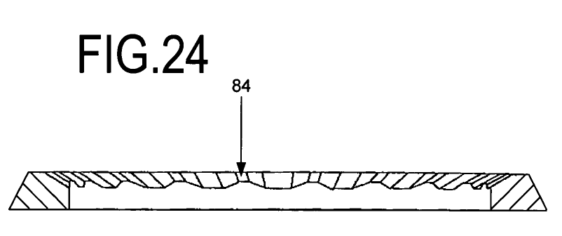

The bearing surface 84 of this embodiment is configured to cooperate with an annular surface 72. As depicted in FIG. 24, the bearing surface 84 is undulating in shape and is preferably provided with an annularly extending series of surfaces, which provide a uniform undulation around the entire bearing surface 84.

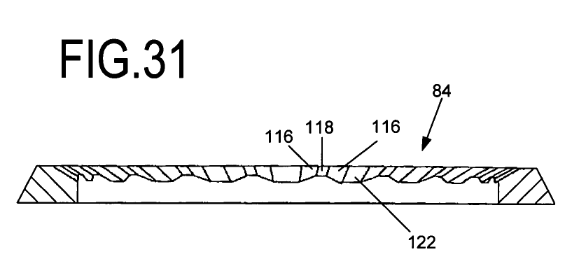

FIG. 31 depicts yet another alternative embodiment of the present invention. As depicted therein, the bearing surface 84 is provided with a plurality of upper peaks of an undulation. The upper peaks are provided as plateaus 118. The plateaus 118 are generally spherically concave

The plateaus 118 are adjacent to a plurality of faces 116. Each plateau 74 is adjacent to a pair of faces 116. The bearing surface 84 of this alternative embodiment is provided with an annularly extending series of faces 116, which form a uniform undulation around the entire surface. The faces 116 are configured to correspond to faces 73 on the annular surface 72. As depicted in FIG. 31, the faces 116 are generally spherically concave.

Each face 73 is adjacent to a valley 122. Each valley 122 is adjacent to a pair of faces 116. The valleys 122 are configured to be wider than valleys 75 on the annular surface 72.

As depicted in FIG. 31, the valleys 122 are generally spherically concave and have a predetermined depth. In one embodiment, the depth is dimensioned according to the number of threads on the nut. The valleys 122 are formed in the forging process so that they are all concave and lie on the surface of an imaginary sphere whose center is on the axis of the washer body 82. The radius of that sphere ranges from 0.1 inches to 2.00 inches. As such, it will be seen that the plateaus 74 on the nut body 62 are perfectly complementary in shape to the valleys 122 on the washer body 82.

The valley 122 and adjacent faces 116 of the alternative embodiment provide an inverted Vee shape profile. The Vee shaped profile provides the plateaus 118 with a height. Advantageously, the height is dimensioned according to the distance between the plateau 74 and the valley 75. In the embodiment shown herein, the height equals the vertical distance between the plateau 118 and the valley 122. The height is preferably slightly greater than the clearance between the threads at 64 and those on a stud 26, when the fastener assembly 50 is in place. In this alternative embodiment, the height ranges between 0 inches and 0.030 inches.

In an alternative embodiment, the height is dimensioned according to the number of threads, measured axially, per inch on the nut. Advantageously the height is related to the number of faces 73 or faces 116. By way of example and not limitation the height, in inches, is proportional to the number of threads per inch and the number of Vee shaped undulations. In the preferred embodiment, the height is proportional to the product of the number of threads per inch and the number of Vee shaped undulations. The height of this alternative embodiment ranges up to approximately 0.04167 of an inch.

In the preferred embodiment, washer body 82 is provided with a clamping surface 86. As depicted in FIG. 13, the clamping surface 86 is provided on the outer end 88 of the washer body 82. In the presently preferred embodiment, the clamping surface 86 is generally flat.

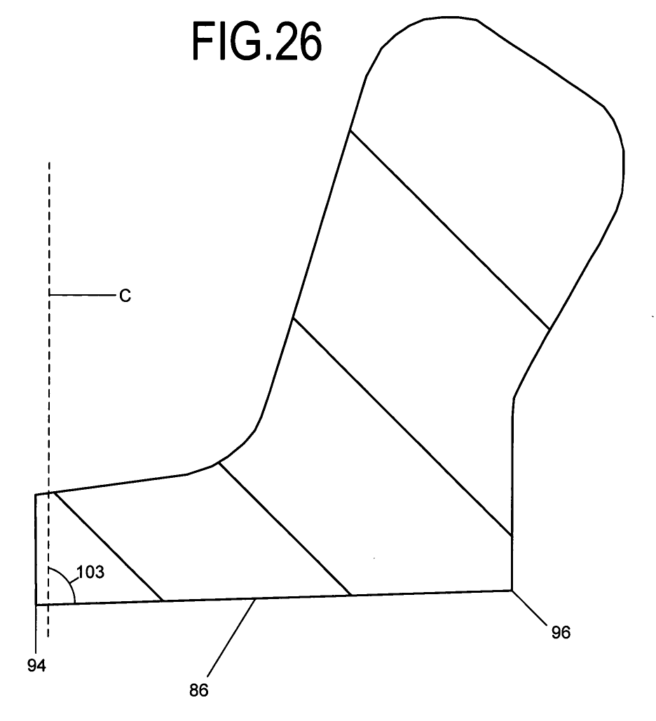

In an alternative embodiment, the washer 54 is provided with a clamping surface 86. The clamping surface 86 is slightly more concave and located on the bottom of the washer 54. The clamping surface 86 forms what approximates a shallow frustum of a cone. The clamping surface 86 is preferably inclined upwardly from the outer periphery 94 of the bottom of the washer flange 92 toward the inner periphery 96 of the body 82. The clamping surface 86 is at an angle 103 with respect to the axis of the nut, depicted in FIG. 26 as imaginary line C. Angle 103 ranges from 87° to 90°. In this alternative embodiment, the angle 103 is 88°.

In another alternative embodiment, the washer 54 is provided with a plurality of depressions 104. The plurality of depressions 104 provide the clamping surface 86 with clamp segments 106. Advantageously, the clamp segments 106 are configured to flex axially.

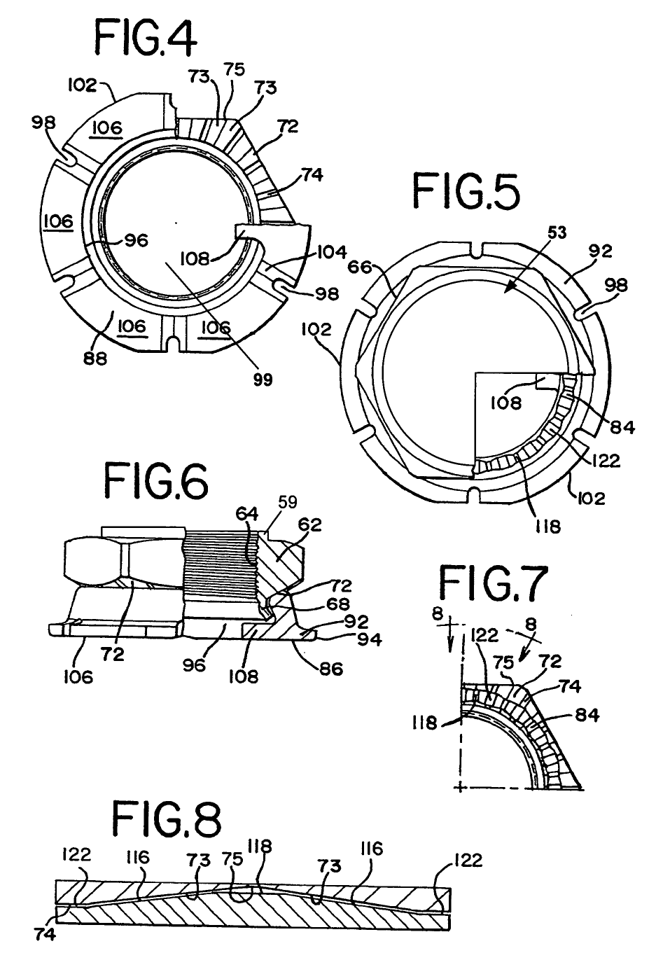

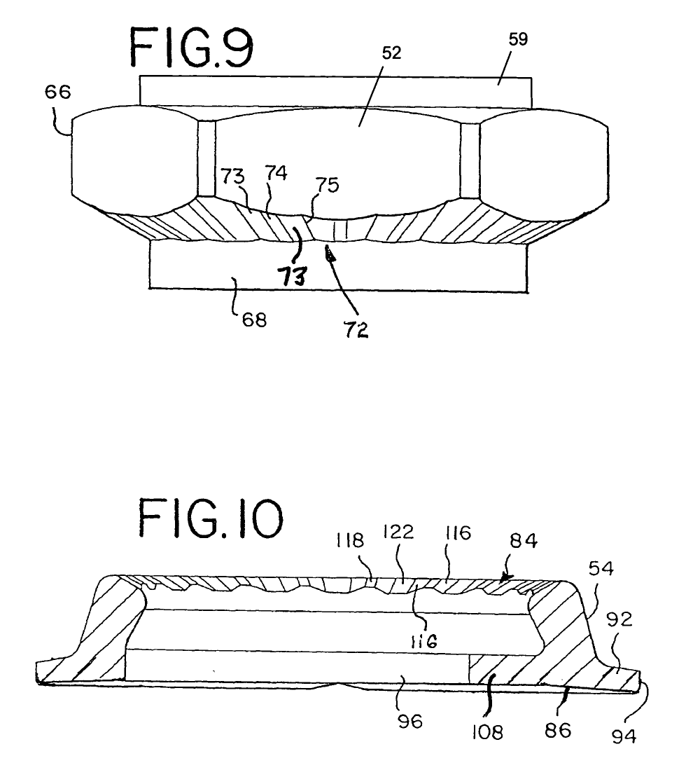

Referring to FIG. 4, the depressions 104 are located on the bottom of the flange 92 and the outer face 88 of the washer body 82. In this alternative embodiment, the depressions 104 extend radially inward from corresponding cut-outs 98. As depicted in FIG. 4, the clamping surface 86 is provided with six depressions 104-that are generally Vee shaped. However, those skilled in the art will appreciate that any number of depressions may be employed.

In the alternative embodiment depicted in FIG. 4, the depressions 104 effectively separate the annular clamp surface 86 into six clamp segments 106 that are provided with an arcuate shape. The arcuate outer extremities of the clamp segments 106 are located between the cut-outs 98 and are able to resiliently flex axially of the washer 54.

In an alternative embodiment, the washer 54 is provided with an ear 108. The ear 108 is configured to cooperate with a stud 26. The ear 108 cooperates with a slot 49 provided on at least a portion of the stud 26. The ear 108 is of a size and shape suitable to slide loosely in an axially elongated slot 49 formed on one side of the threaded end section of a stud 26 or spindle 12. The ear 108 preferably cooperates with the slot 49 to prevent the washer 54 from rotating with respect to the stud 26 or spindle 12.

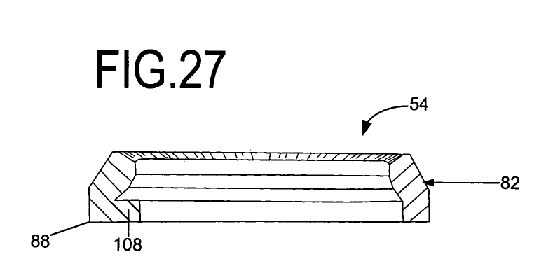

FIG. 27 depicts an ear 108 extending inward from end face 88 washer body 82. FIG. 10 depicts the ear 108 extending inwardly of the base of the washer body 82, opposite a flange 92. Referring now to FIG. 34, the ear 108 is depicted cooperating with a slot 49 on a portion of a stud 26.

Those skilled in the art will appreciate that the invention contemplates the use of other conventional means for preventing washer rotation. In the alternative, a flat may be formed on the stud 26 or a spindle 12 and a corresponding flat formed inwardly of the washer body 82.

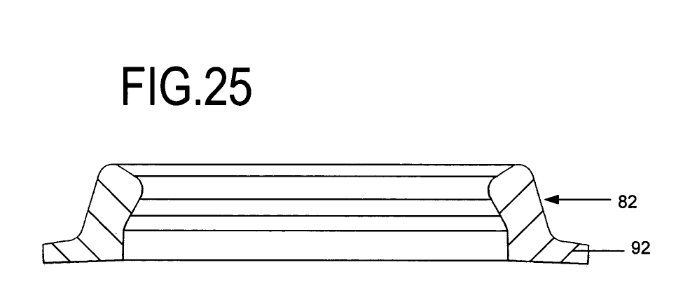

FIG. 25 depicts yet another alternative embodiment of the present invention. As shown therein, the washer 54 is provided with a flange 92. The flange 92 extends outward from the washer body 82. In this alternative embodiment, the flange 92 is between 0.05 inches and 0.12 inches thick.

In another alternative embodiment the flange 92 is provided with a plurality of slots formed inwardly from its outer edge, at regular intervals around the flange 92. The slots permit intervening flange sections 102 to resiliently flex, albeit only slightly, when the clamping surface 86 is forced against a surface and is under the desired load.

FIG. 5 depicts the flange 92 provided with slots in the form of a plurality of cut-outs 98. The cut-outs 98 provide the flange 92 with a plurality of flange sections 102. Advantageously, the flange sections 102 are configured to flex axially. The flange sections 102 are configured to flex an axial distance which is slightly greater than the clearance between the threads on the stud and the threads on the nut 52.

In the alternative embodiment depicted in FIG. 5, the cut-outs 98 are generally U shaped. However, in other embodiments, cut-outs 98 are in other shapes such as a circular or polygonal shape.

In the alternative embodiment depicted in FIG. 5, the flange 92 is provided with a plurality of cut-outs 98. The number of cut-outs 98 in the flange 92 are provided according to the size of the flange 92. Advantageously, the number of cut-outs 98 is based upon the thickness of the flange 92. The embodiment depicted in FIG. 5, is provided with six cut-outs 98, yielding six flange sections.

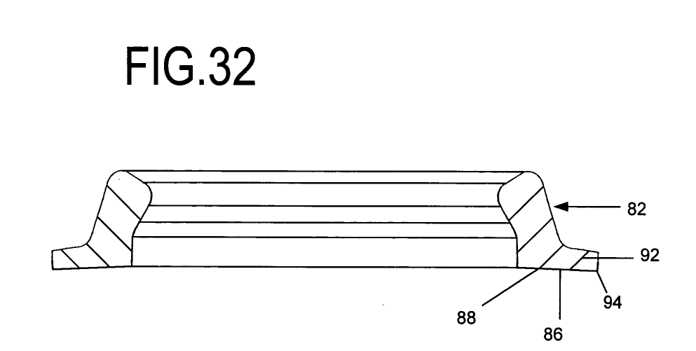

In an alternative embodiment of the present invention, the washer 54 is provided with a clamping surface 86. Referring to FIG. 32, at least a portion of the clamping surface 86 is located on the flange 92. As shown therein, the clamping surface 86 is located on the bottom of the flange 92 and the outer face 88 of the washer body 82.

FIG. 29 depicts the nut 52 and cap 53 assembled in the preferred embodiment. The nut 52 and cap 53 are preferably assembled by interference fitting the inner surface 81 of the cap 53 around the retaining surface 59. Thereafter, frictional forces acting on frictional surface 55 and frictional surface 70 retain the cap 53 on the nut 52.

FIG. 20 depicts the nut 52 and washer 54 assembled in the preferred embodiment. As depicted therein, the nut 52 and washer 54 are preferably assembled by inserting the skirt 68 into the washer 54, whereby the annular surface 72 is opposed to the bearing surface 84. Thereafter, at least a portion of the collar 85 is forced outward to provide skirt 68. The skirt 68 is configured to underlie a portion of the washer 54, whereby it loosely but securely connects the nut 52 and washer 54, while permitting the nut 52 to rotate freely relative to the washer 54.

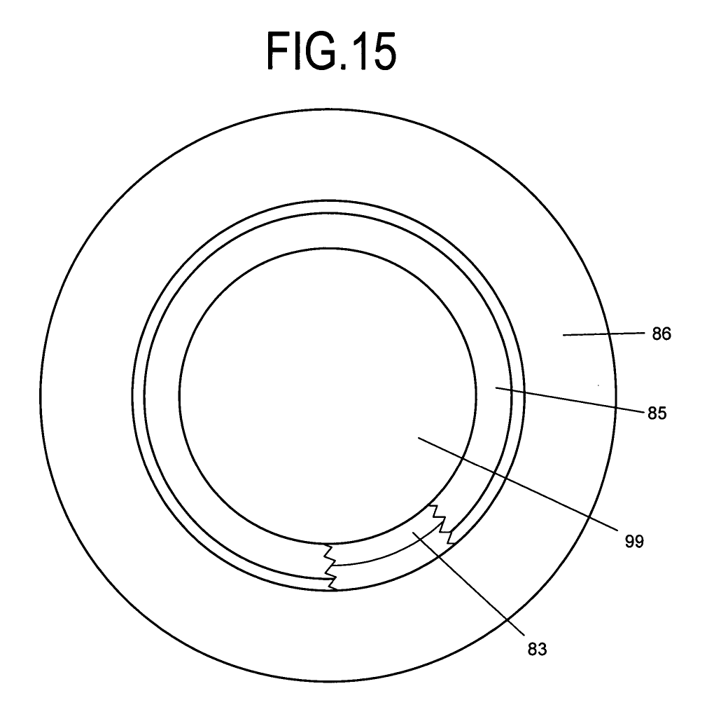

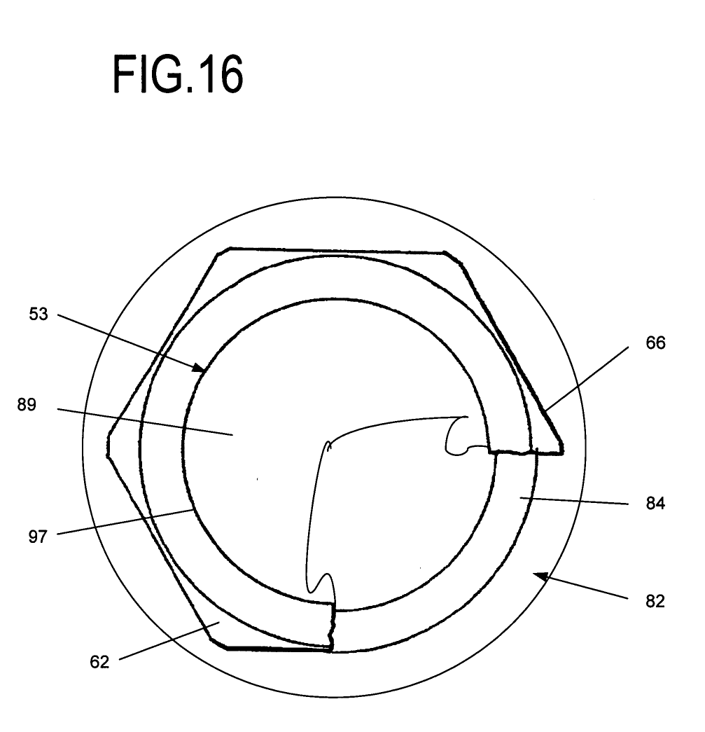

FIG. 15 depicts the preferred embodiment, wherein at least a portion of the skirt 68 underlies an annular inward-projection 83 around its circumference. However, those skilled in the art will appreciate that the collar 85 can be forced outward at space locations, to provide a skirt 68 which underlies a portion of the projection 83.

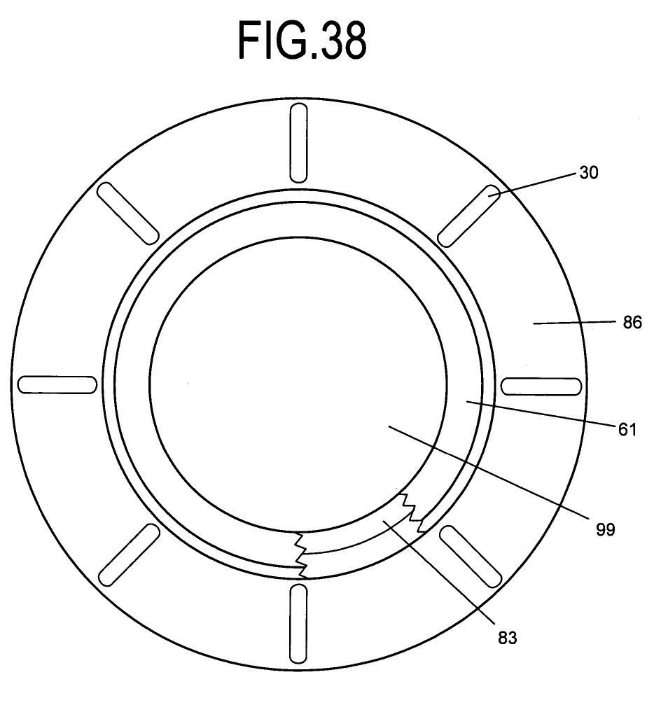

FIG. 38 depicts the clamping surface 86 of an alternative embodiment. As shown therein the clamping surface 86 is provided with a plurality of protrusions 30. The protrusions 30 provide the clamping surface 86 with a higher frictional coefficient.

The clamping surface 86 is configured to prevent the washer 54 from rotating. The protrusions 30 frictionally engage the surface that is being fastened o prevent the washer 54 from rotating with respect to the surface. FIG. 38 depicts a clamping surface 86 that is provided with eight (8) protrusions; however, a clamping surface 86 may be provided with more than eight (8) protrusions, such as twelve (12) protrusions.

In the preferred embodiment, the fastener assembly 50 is rotated onto the stud 26. During the rotation the internally threaded nut 52 engages threads on the stud 26, whereby the fastener assembly travels axially toward the wheel hub 20. During this rotation, both the nut 52 and the washer 54 are able to rotate with respect to the stud 26.

Upon further rotation, the clamping surface 86 engages a surface of the wheel hub 20 that is adjacent to the stud 26. Further axial travel of the fastener assembly 50 is resisted by this surface. The resistance is at first relatively slight, however, upon further rotation the resistance increases until the fastener assembly 50 is secured to the stud 26.

However, in alternative embodiments, a fastener assembly 150 can be threaded onto spindle 12. As depicted in FIGS. 1 and 2 the fastener assembly 150 of an alternative embodiment is threaded onto spindle 12. As shown therein, the outer bearing assembly 29 can be held in operating relationship against the shoulder 39 and spacer 41 by a fastener assembly 150 of an alternative embodiment. In this regard, the fastener assembly 150 is threaded onto the threaded outer end section 45 of the spindle 12 and seats against the inner bearing race 47 of the bearing assembly 29.

The fastener assembly 150 is threaded onto the end section 45 of the spindle 12 to take up undesired play in the bearing assemblies 28 and 29 and, accordingly, hold them both in proper operating position and relationship. If the fastener assembly 150 is threaded too snugly against the bearing race 47, the bearing assemblies 28 and 29 will both be over-loaded and their operating life shortened. If the fastener assembly 150 is not threaded sufficiently far onto the end section 45, the bearing assemblies 28 and 29 will have too much play and their operating life will be shortened. The fastener assembly 150 of this alternative embodiment is designed to be turned onto the threaded end section 45 of the spindle 12 to a desired position and then held securely in that position by locking forces exerted internally of the assembly according to the invention.

In an alternative embodiment, the fastener assembly 150 is configured for securing a wheel hub 20 on a stud 26 that is provided as a spindle 12 in an axle assembly 10 of a truck or some other vehicle. For example, after a wheel hub 20 has been seated on its supporting bearing assemblies 28 and 29, a fastener assembly 150 is slipped over the threaded end section 45 of the spindle 12 so that the ear 108 in the washer 54 slides along the slot 49 in the spindle 12 until the internal threads 64 engage the external threads on the spindle 12. As the nut 52 rotates while being threaded onto the spindle 12 the washer 54 is pushed freely in front of it without rotating. In this way, the washer 54 moves axially with it but is prevented from rotating because its ear 108 is axially slidable in, but rotationally fixed by, the slot 49 in the spindle 12.

All the while, the nut 52 and washer 54 are seated against each other in nested relationship. In this nested relationship, each plateau 74 will seat uniformly on a corresponding valley 122 while opposed inclined faces 73 and 116 will be slightly separated. In this relationship, the peaks, provided as plateaus 74 and plateaus 118, on the annular surface 72 and bearing surface 84, respectively, ride over each other. As such, the annular surface 72 slips easily over the bearing surface 84 on the washer 54 as the nut 52 pushes the washer 54 before it.

The nut 52 is further threaded onto the spindle 12 by hand until the clamp surface 86 on the washer body 82 engages the inner bearing race 47. When the clamp surface 86, having a frusto-conical shape, engages the inner bearing race 47, further rotation of the nut is resisted.

The resistance is at first relatively slight, however, upon further rotation the resistance increases. As such, the peaks ride over each other with greater and greater difficulty as the load increases. The resistance increases with greater and greater effect by the interlocking effect of the faces 73 on the nut 52 and the faces 116 on the washer 54. Eventually, they can slip past each other only when the flange sections 102 on the washer 54 begin to resiliently flex. As the nut turns and axial pressure builds up in the bearing assemblies 28 and 29. As this pressure builds, the flange sections 102 begin to flex.

The flange sections 102 are designed to resiliently flex through an axial distance which is slightly greater than the clearance between the spindle 12 threads and the nut body 62 threads. Because the flange sections 102 are able to flex slightly more than this clearance, the washer 54 can move axially under load to some degree without degradation of the lock between washer 54 and nut 52. At the same time, because the height of the plateau 118 above the valley 122 in the washer body 82 is slightly greater than the clearance also, once a locking relationship is established with the proper preload the nut 52 and washer 54 can move slightly relative to each other without loosening the fastener assembly 150.

The flexing creates a resilient force tending to keep the faces 73 on the nut 52 and the faces 116 washer 54 in an interlocked relationship. In this locked relationship, a constant bearing load is resiliently maintained and the peaks of the nut 52 and washer 54 are seated generally flush against corresponding valleys 122 and valleys 75, respectively. Also, the faces 73 seat generally flush against the faces 116 and prevent the fastener assembly 150 from backing off. In particular, the leading faces 73 seat against trailing faces 116. Moreover, because the faces 73 and faces 116 are preferably provided so as to be complementarily spherically convex and spherically concave, respectively, and all their radii of curvature axially of the fastener assembly 150 and from its axis equal those of the aforementioned valleys 122, locking surface contact is maintained between them even if the nut 52 and washer 54 are not precisely parallel to each other because the nut does not thread perfectly square onto the spindle 12.

When a predetermined torque setting is reached in turning the nut 52 of the locking assembly 50 onto the spindle 12, the bearing assemblies 28 and 29 are properly preloaded. The locking assembly 50 can then be relied upon to resist all axial forces tending to cause the nut 52 to back off. Increased axial load from the wheel hub 20 merely causes the nut 52 and washer 54 to become more securely locked together. Only by applying loosening torque to the nut 52 again, as with a hex wrench, can the fastener assembly 150 be removed.

Although the alternative embodiment of this invention has been described in the context of a vehicle wheel hub mounting arrangement, it should be understood that it might be otherwise employed. Its simplicity, rugged construction, virtually fail-proof action, and low manufacturing cost may make it very attractive in many applications.

While a preferred embodiment of the invention has been described, it should be understood that the invention is not so limited, and modifications may be made without departing from the invention. The scope of the invention is defined by the appended claims, and all devices that come within the meaning of the claims, either literally or by equivalence, are intended to be embraced therein.

What is claimed is:

1. A fastener assembly, comprising:
a) a nut having a torque transmitter;
b) the torque transmitter is shaped to transmit torque; and
c) a cap that is shaped according to the nut, wherein the cap is retained on the nut so that an interference fit is achieved between the cap and the nut.

2. A fastener assembly according to claim 1, wherein the cap is configured to cooperate with a wrench.

3. A fastener assembly according to claim 1, wherein the cap is shaped to fit within a wrench.

4. A fastener assembly according to claim 1, wherein the cap is shaped so that a wrench applies torque to the torque transmitter.

5. A fastener assembly, comprising:
a) a nut and a washer rotatable relative to each other about a common axis;
b) an annular surface on the nut and a bearing surface on the washer being axially opposed to each other;
c) the annular surface on the nut and the bearing surface on the washer are undulating in shape; and
d) a clamping surface on the washer.

6. A fastener assembly according to claim 5, further comprising a clamping surface on the washer having a plurality of protrusions.

7. A fastener assembly according to claim 5, wherein the bearing surface and annular surface are undulating in shape and provided with a plurality of plateaus, faces, and valleys.

8. A fastener assembly according to claim 5, further comprising:
a) the bearing surface and annular surface having a plurality of plateaus, faces, and valleys; and
b) a height that is dimensioned according the distance between the plateaus and the valleys and according to a clearance between threads on the nut and threads on a stud.

9. A fastener assembly according to claim 5, further comprising:
a) the bearing surface and annular surface having a plurality of plateaus, faces, and valleys; and
b) a height that is dimensioned according the distance between the plateaus and the valleys, wherein the height is slightly greater than a clearance between threads on the nut and threads on a stud.

10. A fastener assembly according to claim 5, further comprising:
a) the bearing surface and annular surface having a plurality of plateaus, faces, and valleys; and
b) a height that is dimensioned according the distance between the plateaus and the valleys and according to a number of threads per inch on the nut.

11. A fastener assembly according to claim 5, further comprising:
a) the bearing surface and annular surface having a plurality of plateaus, faces, and valleys;
b) the plateaus, faces, and valleys providing the bearing surface and annular surface with a number of Vee-shaped undulations; and
c) a height that is dimensioned according the distance between the plateaus and the valleys and according to the number of Vee-shaped undulations.

12. A fastener assembly according to claim 5, further comprising:
a) the bearing surface and annular surface having a plurality of plateaus, faces, and valleys;
b) the plateaus, faces, and valleys providing the bearing surface and annular surface with a number of Vee-shaped undulations; and
c) a height that is dimensioned according the distance between the plateaus and the valleys and according to the number of Vee-shaped undulations and a number of threads per inch on the nut.

13. A fastener assembly according to claim 5, further comprising:
a) the bearing surface and annular surface having a plurality of plateaus, faces, and valleys;
b) the plateaus, faces, and valleys providing the bearing surface and annular surface with a number of Vee-shaped undulations; and
c) a height that is dimensioned according the distance between the plateaus and the valleys and that is proportional to a product of the number of Vee shaped undulations and a number of threads per inch on the nut.

14. A fastener assembly, comprising:
a) a nut configured to retain a cap;
b) a washer having a bearing surface;
c) the nut and the washer being rotatable relative to each other about a common axis;
d) the nut having an annular surface axially opposed to the bearing surface; and
e) the annular surface and the bearing surface are undulating in shape.

15. A locking fastener assembly according to claim 14, further comprising a clamping surface on the washer.

16. A locking fastener assembly according to claim 14, further comprising a clamping surface on the washer having a plurality of protrusions.

17. A locking fastener assembly according to claim 14, wherein the nut is configured to retain a cap via an interference fit.

18. A locking fastener assembly according to claim 14, further comprising a cap, wherein the cap is retained on the nut so that an interference fit is achieved between the cap and the nut.

19. A fastener assembly, comprising:
a) a nut having a torque transmitter shaped to transmit torque and a retaining surface;
b) the retaining surface is configured to retain the cap;
c) the cap is dimensioned according to the nut, wherein the cap is retained on the nut so that an interference fit is achieved between the cap and retaining surface.

20. A fastener assembly, comprising:
a) a nut having a torque transmitter and a retaining surface;
b) the retaining surface is configured to retain a cap; and
c) the cap is shaped according to the nut, wherein the cap is retained on the nut so that an interference fit is achieved between the nut and the cap.

21. A fastener assembly according to claim 20, wherein the retaining surface is provided with a frictional surface.

22. A fastener assembly according to claim 20, wherein the retaining surface is provided with a frictional surface having an increased frictional coefficient.

23. A fastener assembly according to claim 20, wherein the retaining surface is provided with a plurality of notches at an angle.

24. A fastener assembly according to claim 20, wherein the retaining surface is provided with a frictional surface that is provided with a plurality of notches at an angle between 30° and 60° with respect to an axis of the nut.

25. A fastener assembly according to claim 20, wherein the retaining surface is provided with a frictional surface having a plurality of notches at an angle of 45° with respect to an axis of the nut.

26. A fastener assembly according to claim 20, wherein an inner surface of the cap is shaped so that an interference fit is achieved with the retaining surface.

27. A fastener assembly, comprising:
a) a washer having a bearing surface;
b) a nut having a torque transmitter shaped to transmit torque, a retaining surface configured to retain a cap, and an annular surface that is opposed to the bearing surface on the washer;
c) the washer and nut are assembled together whereby the washer and nut rotate with respect to each other; and
d) the cap is shaped so that a socket wrench applies torque to the torque transmitter rather than the cap and so that an interference fit can be achieved with the retaining surface.

28. A fastener assembly according to claim 27, wherein the annular surface and the bearing surface are undulating in shape.

29. A fastener assembly according to claim 27, wherein the annular surface and the bearing surface are provided with a Vee shaped profile.

30. A fastener assembly, comprising:
a) a washer having a bearing surface;
b) a nut having a torque transmitter shaped to transmit torque, a retaining surface configured to retain a cap, and an annular surface that is opposed to the bearing surface on the washer;
c) wherein the washer and nut are assembled together whereby the washer and nut rotate with respect to each other; and
d) wherein the cap is retained on the nut so that an interference fit is achieved between the cap and the retaining surface.

31. A fastener assembly according to claim 30, wherein the annular surface and bearing surface are undulating in shape.

32. A fastener assembly according to claim 30, wherein the annular surface and the bearing surface include a Vee shaped profile.

33. A fastener assembly, comprising:
a) a washer having a bearing surface;
b) a nut having a torque transmitter shaped to transmit torque, and an annular surface that is opposed to the bearing surface on the washer;
c) the washer and the nut being assembled together whereby the washer and nut rotate with respect to each other; and
d) wherein the annular surface and the bearing surface are provided with a number of Vee shaped undulations.

34. A fastener assembly according to claim 33, further comprising a clamping surface configured to prevent the washer from rotating.

35. A fastener assembly according to claim 33, wherein the washer is provided with a clamping surface having a plurality of protrusions.

36. A fastener assembly according to claim 33, wherein:
a) the nut is provided with a predetermined number of threads per inch;
b) the Vee shaped undulations of the annular surface comprise a plurality of plateaus, faces, and valleys; and
c) wherein a height of the plateaus is dimensioned according to the threads on the nut.

37. A fastener assembly according to claim 33, wherein:
a) the nut is provided with a predetermined number of threads per inch;
b) the Vee shaped undulations of the annular surface comprise a plurality of plateaus, faces, and valleys;
c) wherein a depth of the valleys is dimensioned according to the threads on the nut

38. A fastener assembly according to claim 33, wherein:
a) the nut is provided with a predetermined number of threads per inch;
b) the Vee shaped undulations of the annular surface comprise a plurality of plateaus, faces, and valleys; and
c) wherein a height of the plateaus is dimensioned according to the number of undulations on the annular surface

39. A fastener assembly according to claim 33, wherein:
a) the nut is provided with a predetermined number of threads per inch;
b) the Vee shaped undulations of the annular surface comprise a plurality of plateaus, faces, and valleys; and
c) wherein a depth of the valleys is dimensioned according to the number of undulations on the annular surface.

40. A fastener assembly according to claim 33, wherein:
a) the nut is provided with a predetermined number of threads per inch;
b) the Vee shaped undulations of the bearing surface comprise a plurality of plateaus, faces, and valleys; and
c) wherein a height of the plateaus is dimensioned according to the threads on the nut.

41. A fastener assembly according to claim 33, wherein:
a) the nut is provided with a predetermined number of threads per inch;
b) the Vee shaped undulations of the bearing surface comprise a plurality of plateaus, faces, and valleys;
c) wherein a depth of the valleys is dimensioned according to the threads on the nut

42. A fastener assembly according to claim 33, wherein:
a) the nut is provided with a predetermined number of threads per inch;
b) the Vee shaped undulations of the bearing surface comprise a plurality of plateaus, faces, and valleys; and
c) wherein a height of the plateaus is dimensioned according to the number of undulations on the bearing surface

43. A fastener assembly according to claim 33, wherein:
a) the nut is provided with a predetermined number of threads per inch;
b) the Vee shaped undulations of the bearing surface comprise a plurality of plateaus, faces, and valleys; and
c) wherein a depth of the valleys is dimensioned according to the number of undulations on the bearing surface.

44. A fastener assembly according to claim 33, wherein:
a) the nut is provided with a predetermined number of threads per inch;
b) the Vee shaped undulations of the annular surface comprise a plurality of plateaus, faces, and valleys; and
c) wherein a height of the plateaus is proportional to the product of the number of threads per inch on the nut and the number of Vee shaped undulations on the annular surface.

45. A fastener assembly according to claim 33, wherein:
a) the nut is provided with a predetermined number of threads per inch;
b) the Vee shaped undulations of the annular surface comprise a plurality of plateaus, faces, and valleys; and
c) wherein a depth of the valleys is proportional to the product of the number of threads per inch on the nut and the number of Vee shaped undulations on the annular surface.

46. A fastener assembly according to claim 33, wherein:
a) the nut is provided with a predetermined number of threads per inch;
b) the Vee shaped undulations of the bearing surface comprise a plurality of plateaus, faces, and valleys; and
c) wherein a height of the plateaus is proportional to the product of the number of threads per inch on the nut and the number of Vee shaped undulations on the bearing surface.

47. A fastener assembly according to claim 33, wherein:
a) the nut is provided with a predetermined number of threads per inch;
b) the Vee shaped undulations of the bearing surface comprise a plurality of plateaus, faces, and valleys; and
c) wherein a depth of the valleys is proportional to the product of the number of threads per inch on the nut and the number of Vee shaped undulations on the bearing surface.
